(19) United States
(12) Patent Application Publication
(10) Pub. No.: US 2023/0249180 A1
(43) Pub. Date: Aug. 10, 2023

(54) A multifunctional microfluidic detection chip

(71) Applicant: LANSION BIOTECHNOLOGY CO., LTD., Nanjing (CN)

(72) Inventors: Xingshang Xu, Nanjing (CN); Jeffery Chen, Nanjing (CN)

(73) Assignee: LANSION BIOTECHNOLOGY CO., LTD., Nanjing (CN)

(21) Appl. No.: 18/012,653

(22) PCT Filed: Nov. 1, 2021
(86) PCT No.: PCT/CN2021/127908

§ 371 Date: Dec. 23, 2022

(30) Foreign Application Priority Data
Dec. 1, 2020 (CN) 202011375534.4

(51) Int. Cl. B01L 3/00; B01F 33/301; B01F 23/451; B01F 23/40; B01F 35/83

(52) U.S. Cl. CPC B01L 3/502723; B01F 33/3017; B01F 23/451; B01F 23/483; B01F 35/83; B01F 2101/23

(57) ABSTRACT

The invention discloses a multifunctional microfluidic detection chip. The detection chip comprises a chip body, on which a sample injection chamber, a sample quantitative chamber, a sample overflow chamber, a diluent storage chamber, a diluent quantitative chamber, a diluent overflow chamber, a quantitative mixing chamber, a reaction chamber and vent holes are disposed; a sample to be detected is injected into the sample injection chamber, and enters the sample quantitative chamber through a microfluidic channel, and the excess reaction sample enters the sample overflow chamber, a diluent in the diluent storage chamber enters the diluent quantitative chamber through a microfluidic channel, and the excess diluent enters the diluent overflow chamber; the reaction chamber includes one or more reaction cavities and a sample blank cavity; after the sample in the sample quantitative chamber is mixed with the diluent in the diluent quantitative chamber uniformly in the quantitative mixing chamber, mixed liquid enters the reaction cavities through microfluidic channels and reacts with a reaction reagent for detection, and enters the sample blank cavity at the same time as a sample blank for detection. The invention can effectively reduce the sample consumption, improve the accuracy of the detection results, and simultaneously detect multiple indicators.

### TECHNICAL FIELD

The present invention relates to the field of in vitro microfluidic detection, in particular to a multifunctional microfluidic detection chip.

### BACKGROUND

Microfluidic detection chip technology integrates basic operation units such as sample preparation, reaction, separation, and detection in biological, chemical, and medical analysis processes into a micron-scale chip, and automatically completes the entire analysis process. It has great potential in biology, chemistry, medicine and other fields.

However, the microfluidic detection chip technology in the prior art still has some defects in practical applications, such as complex structure, large sample usage, inaccurate detection results, too small volume ratio between diluent quantitative chamber and sample quantitative chamber, and high production costs. At present, the centrifugal microfluidic detection chip on the market requires a large amount of blood sample, which is not suitable for clinical blood collection and detection of infants, especially newborns and critically ill patients, and lacks effective quality control functions. Therefore, it is necessary to develop a centrifugal detection chip, which has a simple structure, a small amount of sample injection at a time, can detect multiple indicators in a small volume, has low production cost, is suitable for mass production, and has more accurate detection results, and can perform multi-sample detection through chip assembly.

### SUMMARY OF THE INVENTION

The purpose of the present invention is to provide a multifunctional microfluidic detection chip, to overcome the defects of the existing microfluidic detection chip technology, thus the sample consumption can be reduced and the accuracy of the detection results can be further improved.

In order to realize the above-mentioned technical purpose, the present invention adopts the following technical scheme:

A multifunctional microfluidic detection chip comprises a chip body, on which a sample injection chamber, a sample quantitative chamber, a sample overflow chamber, a diluent storage chamber, a diluent quantitative chamber, a diluent overflow chamber, a quantitative mixing chamber, a reaction chamber and vent holes are disposed;

the sample injection chamber is used for injecting a reaction sample to be detected, and is connected to the sample quantitative chamber through a microfluidic channel, the reaction sample enters the sample quantitative chamber from the sample injection chamber, and the excess reaction sample enters the sample overflow chamber;

the diluent storage chamber is connected to the diluent quantitative chamber through a microfluidic channel, a diluent enters the diluent quantitative chamber from the diluent storage chamber, and the excess diluent enters the diluent overflow chamber;

the reaction chamber includes one or more reaction chambers and a sample blank chamber;

after the sample in the sample quantitative chamber is mixed with the diluent in the diluent quantitative chamber uniformly in the quantitative mixing chamber, mixed liquid enters the reaction cavities through microfluidic channels and reacts with a reaction reagent therein for detection, and the mixed liquid enters the sample blank cavity at the same time as a sample blank for detection.

The sample quantitative chamber includes a first sample quantitative cavity and a second sample quantitative cavity.

The reaction chamber includes a plurality of equidistantly distributed reaction cavities.

The volume of the reaction cavities is the same as that of the sample blank cavity.

After the reaction sample in the sample quantitative chamber and the diluent in the diluent quantitative chamber enter the quantitative mixing chamber through microfluidic channel I and microfluidic channel II respectively and are mixed uniformly, the mixed liquid enters the reaction cavities and the sample blank cavity through microfluidic channel III and microfluidic channel IV successively, the microfluidic channel I, the microfluidic channel II and the microfluidic channel III respectively include an inflection point which is close to the center of the chip body relative to the corresponding liquid outflow chamber.

Channel of the sample blank cavity is wider than those of the reaction cavities.

The quantitative mixing chamber and the reaction chamber are respectively communicated with the vent holes.

The quantitative ratio of the reaction sample to the diluent in the quantitative mixing chamber is less than 1:30.

Preferably, the quantitative ratio of the reaction sample to the diluent in the quantitative mixing chamber is 1:50.

The reaction reagent is lyophilized beads prepared by lyophilization.

The lyophilized beads have a radius ranging from 0.5 mm to 1 mm.

The microfluidic channel between the sample quantitative chamber and the sample overflow chamber is provided with a sample vent channel connected to the outside of the chip, and the microfluidic channel between the diluent quantitative chamber and the diluent overflow chamber is provided with a diluent vent channel connected to the outside of the chip.

The chip has a fan-shaped structure.

The chip further includes a chip upper layer and a chip middle layer, and the chip body is located at lower layer.

Two sides of the chip body are respectively provided with a splicing slot.

The chip body is used for detection in biochemical items, immune items, nucleic acid molecule items, and blood coagulation items.

According to the above-mentioned technical scheme, the present invention has the following advantages:

In the present invention, the quantitative ratio of the reaction sample and the diluent is designed to be less than 1:30, and an appropriate ratio of the reaction sample and the diluent is selected as required. After the ratio of the reaction sample and the diluent is determined, a microfluidic detection chip with a fixed structure is designed. In the application, it is only necessary to change the reagent formula required for different detection indicators, and a chip design template can meet the clinical detection of different items or item combination indicators.

In the present invention, the multiple reaction cavities have the same three-dimensional size as the sample blank cavity, so the volume is the same, and the volume of the reaction sample and the diluent entered during the reaction are the same. Therefore, only one sample blank cavity is needed to realize effective quality control of the combination of detection indicators of multiple reaction cavities, and at the same time, the chip structure is simplified and the cost is reduced.

In the present invention, the sample blank cavity is located at the end of the array of reaction cavities, shares a microfluidic channel with the reaction cavity, and can be used as a sample blank cavity and a mixed liquid overflow cavity at the same time. In addition, the sample blank is the mixed liquid of the reaction sample and the diluent, and the detection result eliminates the influence of the sample itself. At the same time, the detection value of the sample blank can detect whether the amount of the sample and the diluent entering the reaction chamber is sufficient. Therefore, it has the dual functions of improving the accuracy of the detection results and judging the validity of the detection.

The blood collection volume of the invention is small, only one drop of blood is needed for one sample injection, and simultaneous detection of multiple indicators can be realized, and the blood sample consumption is only 1/10-⅕ of that of common products on the market. Therefore, it is especially suitable for clinical detection of newborns and long-term tumor patients who have difficulty in blood collection due to radiotherapy, chemotherapy and other reasons.

The chip of the present invention has a fan-shaped structure, and a splicing slot is respectively provided on the left and right edges for splicing two chips. Moreover, three chips can form a circular chip, which can detect three samples at a time, which can greatly increase the throughput of detecting samples.

### BRIEF DESCRIPTION OF THE DRAWINGS

FIG. 1 is a schematic diagram of the overall structure of the multifunctional microfluidic detection chip of the present invention.

FIG. 2 is a schematic diagram of the front structure of the chip body in the multifunctional microfluidic detection chip of the present invention.

FIG. 3 is a schematic diagram of the three-dimensional structure of the chip body in the multifunctional microfluidic detection chip of the present invention.

FIG. 4 is a schematic front view of the overall three-dimensional structure of the multifunctional microfluidic detection chip of the present invention.

FIG. 5 is a schematic rear view of the overall three-dimensional structure of the multifunctional microfluidic detection chip of the present invention.

FIG. 6 is a schematic diagram of the assembled structure of a disc-type multifunctional microfluidic detection chip formed by splicing multifunctional microfluidic detection chips according to the present invention.

FIG. 7 is a schematic diagram of the overall structure of a disc-type multifunctional microfluidic detection chip formed by splicing multifunctional microfluidic detection chips according to the present invention.

Description of Reference Numerals:

1: chip upper layer; 2: chip middle layer; 3: chip body; 4: sample injection chamber; 5: sample cover; 6: sample inlet; 7: sample injection chamber flow channel; 8: sample injection chamber flow channel sealing film; 9. first sample quantitative cavity; 10. second sample quantitative cavity; 11: sample overflow chamber; 12: diluent storage chamber; 13: diluent bag; 14: puncture structure; 15: diluent quantitative chamber; 16: diluent overflow chamber; 17: quantitative mixing chamber; 18: reaction cavity; 191: microfluidic channel I; 192: microfluidic channel II; 193: microfluidic channel III; 194: microfluidic channel IV; 20: splicing slot; 21: sample blank cavity; 221: vent hole I; 222: vent hole II; 23: sample vent channel; 24: diluent vent channel; 25: positioning hole; 261: upper-layer sample injection chamber through hole; 262: upper-layer diluent storage chamber through hole; 263: upper-layer reaction chamber through hole; 264: middle-layer sample injection chamber through hole; 265: middle-layer diluent storage chamber through hole; 266: vent through hole; 267: positioning hole through hole.

### DETAILED DESCRIPTION OF THE INVENTION

The technical solutions of the present invention will be described in detail below with reference to the accompanying drawings. It should be understood that the specific embodiments described herein are only used to explain the present invention, but not to limit the present invention. However, the scope of the present application is not limited by these embodiments, but is subject to the scope of the claims. In order to provide a clearer description and to enable those skilled in the art to better understand the content of the present application, each part in the figures is not necessarily drawn according to its relative size. The proportions of certain sizes and other related scales may be highlighted and thus exaggerated, and irrelevant or unimportant details are not fully drawn for the sake of simplicity.

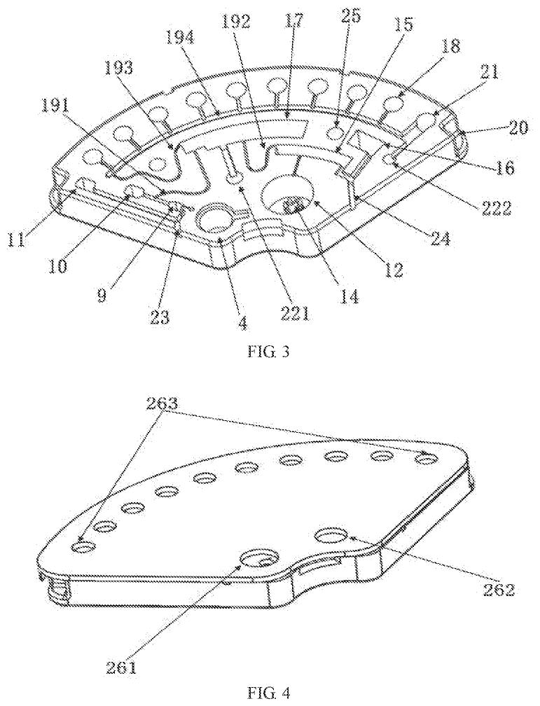

As shown in FIGS. 1-4, the multifunctional microfluidic detection chip of the present invention is made by injection molding, and can be used with detection equipment. The detection chip has a fan-shaped structure, preferably a third of the size of a circle, that is, the angle formed by the intersection of the left and right extension lines is 120 degrees. The fan-shaped structure can be a part of the circle, and other parts can be designed and added according to the needs.

The multifunctional microfluidic detection chip of the present invention includes upper, middle and lower layers. As shown in FIG. 1, from top to bottom, there are a chip upper layer 1 serving as a casing, a chip middle layer 2 serving as a sealing layer, and a lower chip serving as a chip body 3.

As shown in FIG. 1, the chip upper layer 1 is provided with an upper-layer sample injection chamber through hole 261, an upper-layer diluent storage chamber through hole 262, and a set of upper-layer reaction chamber through holes 263. The upper-layer sample injection chamber through hole 261 and the upper-layer diluent storage chamber through hole 262 are located near the center of the chip upper layer 1, and the upper-layer reaction chamber through holes 263 are equally spaced and distributed inside the upper edge of the chip upper layer 1. The upper-layer sample injection chamber through hole 261 is used for adding samples, and the upper-layer diluent storage chamber through hole 262 and each of the upper-layer reaction chamber through holes 263 correspond to the diluent storage chamber 12 and each cavity of the reaction chamber, respectively.

As shown in FIG. 1, the chip middle layer 2 is provided with a middle-layer sample injection chamber through hole 264, a middle-layer diluent storage chamber through hole 265, a set of vent through holes 266 and a set of positioning hole through holes 267. The middle-layer sample injection chamber through hole 264 and the middle-layer diluent storage chamber through hole 265 are located near the center of the chip middle layer 2, corresponding to the upper-layer sample injection chamber through hole 261 and the upper-layer diluent storage chamber through hole 262 in the chip upper layer 1 respectively. The vent through holes 266 and the positioning hole through holes 267 are sequentially farther from the center of the chip middle layer 2 than the middle-layer sample injection chamber through hole 264 and the middle-layer diluent storage chamber through hole 265; the vent through holes 266 correspond to a set of vent holes I 221 and II 222 on the lower chip body 3, and the positioning hole through holes 267 correspond to a set of positioning holes 25 on the lower chip body 3.

As shown in FIGS. 1-3, the chip body 3 is provided with a sample injection chamber 4, a sample quantitative chamber, a sample overflow chamber 11, a diluent storage chamber 12, a diluent quantitative chamber 15, a diluent overflow chamber 16, a quantitative mixing chamber 17, a reaction chamber as well as vent holes I 221 and II 222, and the chambers are connected to each other by microfluidic channels.

The sample injection chamber 4 and the diluent storage chamber 12 are located near the center of the chip body 3. A sample cover 5 is provided on the top of the sample injection chamber 4, and a sample inlet 6 is provided on the sample cover 5 for injecting a sample to be detected. The diluent storage chamber 12 is provided with a diluent bag 13 inside and a puncture structure 14 at the bottom, for injecting a diluent. The sample quantitative chamber includes a first sample quantitative cavity 9 and a second sample quantitative cavity 10, which are communicated with the sample injection chamber 4. The first sample quantitative cavity 9 and the second sample quantitative cavity 10 are farther from the center of the chip body 3 than the sample injection chamber 4. Therefore, when the chip body 3 is driven to rotate by a centrifugal equipment, the sample in the sample injection chamber 4 will flow through the bottom port of the sample injection chamber 4 due to centrifugation, through a reverse flow channel, and then through a front flow channel toward the first sample quantitative cavity 9 and the second sample quantitative cavity 10. The inlet of the reverse flow channel is located at the bottom of the side of the sample injection chamber 4 close to the first sample quantitative cavity 9, and the outlet of the front flow channel is located on the side of the first sample quantitative cavity 9 close to the center of the chip body 3. The reverse flow channel and the front flow channel are connected by a vertical flow channel at the midpoint of the line between the inlet of the reverse flow channel and the outlet of the front flow channel. The sample injection chamber 4 is provided with a sample injection chamber flow channel sealing film 8 on the bottom surface to prevent the sample from overflowing when it flows through the reverse flow channel. The first sample quantitative cavity 9 and the second sample quantitative cavity 10 are provided to achieve better separation of upper plasma and lower blood cells and quantification of plasma samples. The diluent quantitative chamber 15 is communicated with the diluent storage chamber 12, and is farther from the center of the chip body 3 than the diluent storage chamber 12. Therefore, when the chip body 3 is driven to rotate by the centrifugal equipment, the diluent in the diluent storage chamber 12 will flow toward the diluent quantitative chamber 15 because of centrifugation. The volume ratio of the first sample quantitative cavity 9 and the second sample quantitative cavity 10 to the diluent quantitative chamber 15 determines the mixing ratio of the reaction sample and the diluent.

The overflow chamber includes the sample overflow chamber 11 and the diluent overflow chamber 16, which are communicated with the first sample quantitative cavity 9 and the diluent quantitative chamber 15, respectively. The sample overflow chamber 11 is farther from the center of the chip body 3 than the first sample quantitative cavity 9 and the second sample quantitative cavity 10. Therefore, when the chip body 3 is driven to rotate by centrifugation, the sample exceeding the capacity of the first sample quantitative cavity 9 and the second sample quantitative cavity 10 will flow into the sample overflow chamber 11 due to the centrifugation. The diluent overflow chamber 16 is farther from the center of the chip body 3 than the diluent quantitative chamber 15. Therefore, when the chip body 3 is driven to rotate by centrifugation, the diluent exceeding the capacity of the diluent quantitative chamber 15 will flow into the diluent overflow chamber 16 due to the centrifugation.

The microfluidic channel between the first sample quantitative cavity 9 and the sample overflow chamber 11 is also connected to the outside of the chip via a sample vent channel 23. Similarly, the microfluidic channel between the diluent quantitative chamber 15 and the diluent overflow chamber 16 is also connected to the outside of the chip via a diluent vent channel 24. Vent channels are provided for smoother flow of diluent and sample.

The quantitative mixing chamber 17 is communicated with the first sample quantitative cavity 9 and the second sample quantitative cavity 10 through microfluidic channel I 191, and communicated with the diluent quantitative chamber 15 through microfluidic channel II 192, respectively. The quantitative mixing chamber 17 is farther from the center of the chip body 3 than the first sample quantitative cavity 9, the second sample quantitative cavity 10 and the diluent quantitative chamber 15, so that the quantitative sample and the quantitative diluent are mixed and diluted for detection.

The mixed liquid flows from the quantitative mixing chamber 17 to reaction cavities 18 in the reaction chamber through microfluidic channel III 193 and microfluidic channel IV 194 to react with the detection reagents therein. The reaction chamber includes a plurality of equidistantly distributed reaction cavities 18 and a sample blank cavity 21 at the end of the flow channel. The reaction cavities 18 have the same volume, and are provided with reaction reagents required for the reaction. The reaction reagent can be lyophilized beads prepared by lyophilization, and the radius of each lyophilized bead is between 0.5 mm and 1 mm. The small volume of the reaction reagent increases the loading capacity of the reaction cavities 18 in a chip of the same size, which effectively improves the detection sensitivity and detection efficiency. In addition, the use of lyophilized beads for the reaction reagent effectively increases the validity period of the reagent storage.

The channel of the sample blank cavity 21 is wider than the channels of the reaction cavities 18, thereby providing more storage space for the overflow of the mixed liquid in the chip. The sample blank cavity 21 can allow the liquid in the quantitative mixing chamber 17 to enter, to eliminate the influence of different samples on the detection result and to detect whether the amount of reaction sample and diluent entering the reaction cavities 18 is sufficient, so that the detection result is more accurate. In addition, the sample blank cavity 21 in the multifunctional microfluidic chip of the present invention can also be used as a mixed liquid overflow cavity, so that after the reaction in each reaction cavity 18, the excess mixed liquid can enter the sample blank cavity 21.

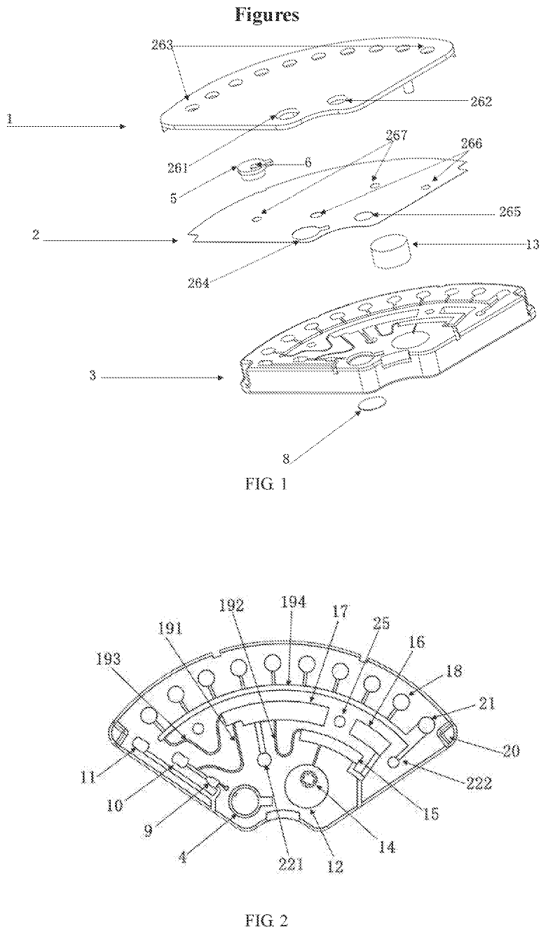

As shown in FIG. 2, the quantitative mixing chamber 17 and the sample blank cavity 21 are respectively communicated with the vent hole I 221 and the vent hole II 222 through microfluidic channels. As shown in FIG. 3, the vent holes I 221 and II 222 penetrate through the chip body 3 located in the lower layer of the chip. As shown in FIG. 5, the vent hole I 221 and the vent hole II 222 can be seen on the back of the chip body 3, and the arrangement of the vent hole I 221 and the vent hole II 222 makes the liquid flow more smoothly.

The diluent stored in the diluent storage chamber 12 is encapsulated in the diluent bag 13 in a liquid state, and the bottom surface of the diluent bag 13 is provided with a sealing film, which is made of a pierceable material, such as plastic, aluminum foil or aluminum-plastic composite material, etc. In the detection, the matching detection instrument squeezes the diluent bag 13 through the upper-layer diluent storage chamber through hole 262 in the chip upper layer 1, so that the sealing film on the bottom surface of the diluent bag 13 is in contact with the puncture structure 14, and then the diluent bag 13 is ruptured, and the diluent inside flows out.

The pipe shapes of the aforementioned microfluidic channel I 191, microfluidic channel II 192 and microfluidic channel III 193 are designed according to the experimental requirements in consideration of capillary action and siphon action. The inflection point of the microfluidic channel I 191 is closer to the center of the chip body 3 than the sample quantitative chamber; the inflection point of the microfluidic channel II 192 is closer to the center of the chip body 3 than the diluent quantitative chamber 15; and the inflection point of the microfluidic channel III 193 is closer to the center of the chip body 3 than the quantitative mixing chamber 17. When centrifugal action is stopped, the capillary action causes the liquid to flow to the inflection point of the microfluidic channel; then centrifugal force is applied, and the liquid flows into the next chamber under the siphon action, which acts as a siphon valve.

The multifunctional microfluidic chip of the present invention also comprises a set of positioning holes 25 located on the left and right sides of the quantitative mixing chamber 17, which are specifically used to ensure the positional accuracy between the layers of the chip, and the layers of the chip are inserted into one body through the positioning holes 25.

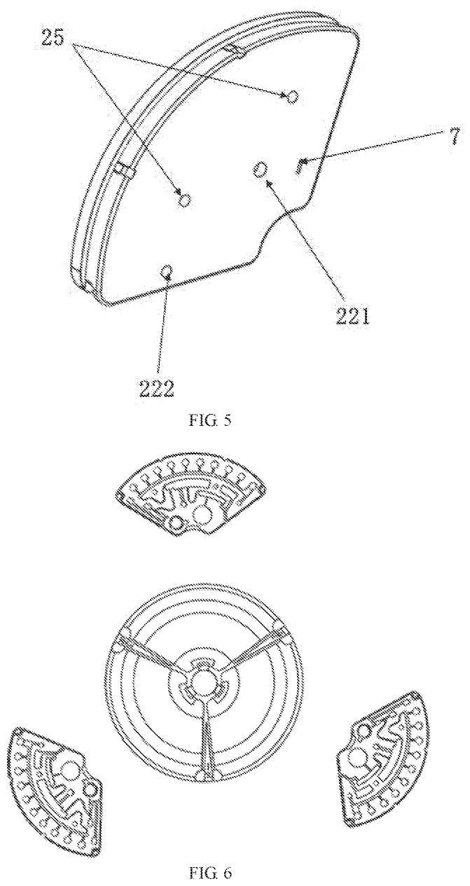

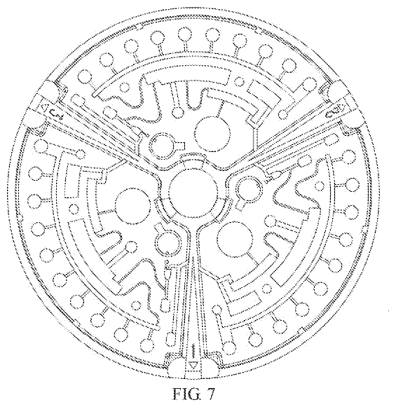

As shown in FIGS. 6 and 7, the multifunctional microfluidic chip of the present invention further comprises splicing slots 20 located on the left and right sides of the upper edge of the chip body 3, which are specifically used for splicing two adjacent chips. And finally, the three fan-shaped chip bodies 3 can be spliced into a circular chip, which further increases the number of detection samples.

The specific steps of using the multifunctional microfluidic detection chip of the present invention are as follows. A whole blood sample enters the sample injection chamber 4 through the upper-layer sample injection chamber through hole 261, and is put into the matching detection instrument. The diluent release structure of the detection instrument squeezes the diluent bag 13 through the upper-layer diluent storage chamber through hole 262, so that the sealing film on the bottom surface of the diluent bag 13 is in contact with the puncture structure 14, and then the diluent bag 13 is ruptured, and the diluent flows out. Under the action of centrifugation, blood and diluent flow through different microfluidic channels respectively. The blood sample enters the first sample quantitative cavity 9 and the second sample quantitative cavity 10, and excess blood enters the sample overflow chamber 11 through the microfluidic channel. The blood sample is centrifuged into an upper layer of plasma and a lower layer of blood cells, and the lower layer of blood cells is mainly deposited in the first sample quantitative cavity 9. The diluent enters the diluent quantitative chamber 15 through the microfluidic channel, and the excess diluent in the diluent quantitative chamber 15 enters the diluent overflow chamber 16 through the microfluidic channel. The configuration of the vent channels makes the flow of the diluent and blood sample smoother, and the centrifugal action can be set to different rotation speeds and centrifugation directions. After the centrifugation is stopped, the plasma and diluent flow to the inflection points of microfluidic channels I 191 and II 192 under capillary action, respectively; centrifugal force is then applied, and the siphon action is used to make the quantitative plasma and diluent enter the quantitative mixing chamber 17. Through the strict centrifugation parameter setting of the instrument, the plasma and the diluent are fully mixed in the quantitative mixing chamber 17. Then, the centrifugation is stopped, the mixed liquid flows to the inflection point of the microfluidic channel III 193 under capillary action again. Then, centrifugal force is applied again, and under the siphon action, the liquid enters each reaction cavity 18 through the microfluidic channel IV 194 successively, and the excess mixed liquid enters the sample blank cavity 21. The reaction cavities 18 each has the same three-dimensional size and volume as the sample blank cavity 21. The immobilized reagent formulas inside the reaction cavities 18 are different. The sample blank cavity 21 is additionally used as a mixed liquid overflow cavity. The arrangement of the vent holes I 221 and II 222 makes the liquid flow smoothly. The mixed liquid dissolves the preset immobilized each reaction reagent (lyophilized beads) in each reaction cavity 18 to fully react with it. The optical path detection device of the matching detection instrument performs optical detection on each reaction cavity, and calculates the detection result.

The ratio of the reaction sample to the diluent in the present invention is fixed, and the ratio is designed to be less than 1:30, for example, 1:40, 1:50, etc., which are designed according to practical application needs. Under the condition that the ratio of the reaction sample and the diluent is determined, a microfluidic chip with a fixed structure is designed, and the simultaneous detection of multiple indicators can be realized only by changing the detection reagent formula in each reaction cavity 18. In addition, the blood collection volume is small, and only 20 μL (one drop of blood) is needed for a single injection, which can realize the simultaneous detection of multiple indicators. The blood sample consumption is only one-tenth to one-fifth of that of common products on the market. Therefore, it is especially suitable for clinical detection of newborns and long-term tumor patients who have difficulty in blood collection due to radiotherapy, chemotherapy and other reasons. In the reaction chamber, the difference between the solution in the sample blank cavity 21 and the solution in each reaction cavity 18 is that the former does not contain a reaction reagent. That is to say, the mixed liquid after mixing the reaction sample and the diluent is used as the sample blank, which can greatly improve the reliability of the detection result.

As shown in FIG. 2, when the ratio of reaction sample and diluent is fixed at 1:50, after centrifugation, 4 μL of quantitative plasma and 200 μL of quantitative diluent are mixed into the plurality of reaction cavities 18 and the sample blank cavity 21 with the same volume. Because the volumes of the reaction sample and the diluent in the reaction cavities 18 are all the same, only one sample blank cavity 21 is required to achieve effective quality control of several detection indicators of the chip, and at the same time, the chip structure is simplified and the cost is reduced.

The multifunctional microfluidic detection chip of the present invention can be used for detection items including biochemical items, immune items, nucleic acid molecule items, and blood coagulation items. Specific indicators of biochemical items include total bilirubin, direct bilirubin, total bile acids, total protein, albumin, albumin/globulin, alanine aminotransferase, aspartate aminotransferase, alkaline phosphatase, gamma-glutamyl transpeptidase, potassium, sodium, chloride, calcium, magnesium, phosphorus, iron, carbon dioxide, ammonia, aspartate aminotransferase mitochondrial isoenzyme (ASTm), lactate dehydrogenase (LDH), creatine kinase (CK), alpha-hydroxybutyrate dehydrogenase (α-HBD), creatine kinase isoenzyme (CK-MB), blood urea nitrogen (BUN), creatinine (Cr), cystatin C (Cys C), uric acid, neonatal hypoxic ischemic encephalopathy; glucose, cholesterol, triglycerides, free fatty acids, phospholipids, CRP, alpha-fetoprotein, cholinesterase, amylase.

Indicators of immune items include cardiac troponin I, procalcitonin, N-terminal brain natriuretic peptide precursor, thyroid stimulating hormone, total triiodothyronine, free triiodothyronine, total thyroxine, free thyroxine, estradiol, anti-Mullerian hormone, brain natriuretic peptide, cardiac fatty acid-binding protein, interleukin-6, lipoprotein-related phospholipase A2, serum amyloid A, soluble growth-stimulating expression gene 2 protein, creatine kinase isoenzyme CK-MB, myoglobin Myo, luteinizing hormone, follicle-stimulating hormone, prolactin, testosterone, progesterone, 25-hydroxyvitamin D3, 25-hydroxyvitamin D, immunoglobulin G4, cardiac troponin T, myeloperoxidase, aldosterone, renin, homocysteine, D-dimer, S100-beta protein, galectin 3, human growth differentiation factor 15, P-selectin, renin activity, angiotensin I, angiotensin II, high-sensitivity cardiac troponin I.

Indicators of nucleic acid molecule items include Mycoplasma pneumoniae, Chlamydia pneumoniae, Legionella pneumophila, Influenza A virus, Influenza B virus, Bacillus pertussis, Streptococcus pneumoniae, Respiratory syncytial virus, Parainfluenza virus, Rhinovirus, Respiratory adenovirus.

Indicators of blood coagulation items include prothrombin time (PT), thrombin time (TT), activated partial thromboplastin time (APTT), activated coagulation time (ACT), fibrinogen (FIB), fibrin degradation product (FDP), coagulation factor Xa, Russell-viper-venom time (RVVT), Antithrombin III (AT III), D-dimer.

In the non-limiting biochemical detection application example of the present invention, each detection reagent was firstly fixed in each reaction cavity 18. Lyophilized (freeze-dried) beads were prepared by lyophilization (freeze-drying), and each lyophilized bead had a diameter of 0.5-1.0 mm, and the beads were stored in a dry state at 4-8° C. The specific steps were:

Frozen beads preparation: the drop volume of automatic bead drop machine (Xiamen Wumen Automation Technology Co., Ltd.; LC200-R) was adjusted to be accurate to 2-100 μL (preferably 4 μL) per drop of reagent beads. A matching thermal insulation container containing liquid nitrogen was installed, parameters such as the liquid level height were adjusted, and then bead drop was started. Each reagent was dropped into liquid nitrogen to quickly form frozen beads and sink to the bottom of the liquid nitrogen container. Finally, the frozen beads were poured into a freeze-drying container for further vacuum freeze-drying.

Preparation of freeze-dried (lyophilized) beads: the above frozen beads were placed into a vacuum freeze-drying instrument (Shanghai Tofflon Technology; LYO-0.5). Instrument parameters were set, drying time was 24-28 hours, the frozen beads were dehydrated to form freeze-dried beads, and after completion, they were taken out and placed in a closed container.

The microfluidic detection chip of the present invention has a fixed structure, and the ratio of reaction sample to diluent is designed to be 1:50. Using the multifunctional microfluidic detection chip of the invention, only 20 μL of whole blood is needed for one sample injection. The chip is placed in a matching detection instrument. The diluent flows out from the diluent storage chamber 12 and enters the diluent quantitative chamber 15, and the excess diluent enters the diluent overflow chamber 16. The whole blood sample is stratified after centrifugation, the blood cells are mainly deposited in the first sample quantitative cavity 9, and the plasma is in the second sample quantitative cavity 10. 4 μL of quantitative plasma and 200 μL of quantitative diluent are mixed in quantitative mixing chamber 17, and then enter nine reaction cavities 18 and one sample blank cavity 21 with the same volume. The mixed liquid dissolves each immobilized reaction reagent in each reaction cavity 18 and reacts fully with it. The optical path detection device of the matching detection instrument performs optical detection on each reaction cavity 18 and the sample blank cavity 21 to obtain the detection result.

The detection results of the nine reaction cavities 18 are subtracted from the detection results of the sample blank cavity 21, which eliminates the influence of different samples on the results. It can also be checked whether the amount of the reaction sample and the diluent entering each reaction cavity 18 is sufficient. Therefore, it has the dual functions of improving the accuracy of the detection results and judging the validity of the detection.

The blood sample consumption of the present invention is only 1/10-⅕ of that of common products on the market, and the blood collection volume is small, and is especially suitable for clinical detection of newborns and long-term tumor patients who have difficulty in blood collection due to radiotherapy, chemotherapy and other reasons. The structure of the microfluidic detection chip is fixed, and the ratio of reaction sample and diluent is fixed. Only by changing the reagent formula required for different detection indicators, a single chip design template can be used to realize the clinical detection of different items or item combinations.

The configuration of the splicing slots 20 can assemble three detection chips into one circular detection chip, and can detect three different samples at the same time, thereby increasing the throughput of detecting samples.

1. Taking nine indicators of liver function as an example, compared with Products 1 and 2 on the market, the results of the sample to detection reagent volume ratio of the present invention are as follows:

| | | Indicator | Indicator | Indicator | Indicator | Indicator | Indicator | Indicator | Indicator | Indicator |
|---|---|---|---|---|---|---|---|---|---|---|
| | | 1 | 2 | 3 | 4 | 5 | 6 | 7 | 8 | 9 |
| | Product | (TP) | (ALB) | (TB) | (DB) | (TBA) | (AST) | (ALT) | (ALP) | (GGT) |
| Sample to | Product | 1:100 | 1:100 | 1:35 | 1:35 | 1:80 | 1:25 | 1:25 | 1:50 | 1:18.7 |
| Reagent | 1 | | | | | | | | | |
| Volume | Product 2 | 1:61 | 1:60 | 1:75.5 | 1:21.5 | null | 1:8.4 | 1:8.4 | 1:32.9 | 1:15 |
| Ratio | Invention | 1:50 | 1:50 | 1:50 | 1:50 | 1:50 | 1:50 | 1:50 | 1:50 | 1:50 |

The sample-to-reagent ratio of Products 1 and 2 is not fixed. Instead, the invention uses the chip as the carrier to realize the fixation of the sample-to-reagent ratio, and then the structure of the chip is fixed, the three-dimensional size and volume of the reaction pool are the same, and the same amount of sample entering the reaction pool is ensured, and only the reagent formulas for different detection indicators need to be changed. Therefore, the chip structure is fixed, the cost of molding is reduced, and mass production is facilitated.

2. Compared with Product 3, the present invention detects nine indicators, and the blood volume of each indicator is roughly calculated to be 2.2 μL. In fact, only one drop of blood can be used to detect nine indicators, and the blood collection volume is small. It is especially suitable for clinical detection of newborns and long-term tumor patients who have difficulty in blood collection due to radiotherapy, chemotherapy and other reasons.

| Product | Product 3 | Invention |
|---|---|---|
| Blood injection volume | ≥120.0 μL | 20 μL |
| Number of detection | ≤16 | 9 |
| indicators | | |
| Blood volume/indicator | ≥7.5 μL | 2.2 μL |

3. The performance parameters of the present invention and Product 3 (as a control) are compared as follows:

Compared with the product performance parameters of Product 3, the performance parameter standard requirements of the product of the present invention are as follows:

| | | Indicator | Indicator | Indicator | Indicator | Indicator | Indicator | Indicator | Indicator | Indicator |
|---|---|---|---|---|---|---|---|---|---|---|
| | Performance | 1 | 2 | 3 | 4 | 5 | 6 | 7 | 8 | 9 |
| Product | parameters | (TP) | (ALB) | (TB) | (DB) | (TBA) | (AST) | (ALT) | (ALP) | (GGT) |
| Product | Accuracy | ≤10% | ≤10% | ≤15% | ≤15% | ≤15 | ≤15 | ≤15 | ≤15% | ≤15 |
| 3 | Repeatability | ≤10% | ≤10% | ≤15% | ≤15% | ≤15 | ≤20 | ≤20 | ≤15% | ≤11 |
| | Batch-to- | ≤15% | ≤15% | ≤15% | ≤15% | ≤15% | ≤20% | ≤20% | ≤15% | ≤15% |
| | batch | | | | | | | | | |
| | variation | | | | | | | | | |
| Invention | Accuracy | ≤8% | ≤8% | ≤12% | ≤12% | ≤12% | ≤12% | ≤12% | ≤12% | ≤12% |
| | Repeatability | ≤7% | ≤6% | ≤12% | <12% | ≤12% | ≤12% | ≤12% | ≤12% | ≤12% |
| | Batch-to- | ≤12% | ≤12% | ≤12% | ≤12% | ≤12% | ≤12% | ≤12% | ≤12% | ≤12% |
| | batch | | | | | | | | | |
| | variation | | | | | | | | | |

The specific embodiment data are as follows:

(1) Accuracy

| | TP | ALB | TB | DB | TBA | AST | ALT | ALP | GGT |
|---|---|---|---|---|---|---|---|---|---|
| Indicator | (g/L) | (g/L) | (μmol/L) | (μmol/L) | (μmol/L) | (U/L) | (U/L) | (U/L) | (U/L) |
| Randox | 59.4 | 41.6 | 27.9 | 17 | 23.2 | 35 | 38 | 170 | 49 |
| standard | | | | | | | | | |
| Detection | 55.7 | 42.5 | 27.7 | 16.4 | 23.7 | 32.1 | 38.8 | 162 | 50.8 |
| result | 56.3 | 39.7 | 28.9 | 18.1 | 23.1 | 33.9 | 34.6 | 175.8 | 51.4 |
| | 61.9 | 43.1 | 26.8 | 17.1 | 22.2 | 34.6 | 37.1 | 167.4 | 46.8 |
| Relative | −6.23% | 2.16% | −0.72 | −3.53% | 2.16 | −8.29% | 2.11% | −4.71 | 3.67 |
| deviation | −5.22% | −4.57% | 3.58 | 6.47% | −0.43 | −3.14% | −8.95% | 3.41 | 4.9 |
| | 4.21% | 3.61% | −3.94 | 0.59% | −4.31 | −1.14% | −2.37% | −1.53 | −4.49 |
| Standard | +8% | +8% | +12% | +12% | +12% | +12% | +12% | +12% | +12% |
| requirement | | | | | | | | | |

(2) Precision

| Indicator | | ALB | TB | | | | | |
|---|---|---|---|---|---|---|---|---|
| Nominal | TP (g/L) | (g/L) | (μmol/L) | | DB (μmol/L) | | TBA (μmol/L) | |
| value | 72.6 | 42.7 | 29.1 | 99.8 | 16.1 | 31.4 | 25.1 | 45.8 |
| 1 | 77.5 | 44.8 | 29.6 | 108.6 | 16.3 | 27 | 26.9 | 44.7 |
| 2 | 70.9 | 43.5 | 27 | 102 | 17.5 | 31.3 | 22.2 | 48.3 |
| 3 | 76.8 | 43.7 | 26.5 | 113 | 17 | 30.6 | 25.8 | 46.3 |
| 4 | 72.7 | 46.1 | 27.1 | 117.5 | 14.9 | 31.8 | 26 | 45.3 |
| 5 | 76.5 | 40.8 | 28 | 107.8 | 16.1 | 29.8 | 23.9 | 45.2 |
| 6 | 72 | 43.5 | 30.6 | 120.1 | 17.4 | 26.3 | 27.3 | 47.9 |
| 7 | 75.1 | 40.9 | 29.7 | 106.5 | 14.7 | 30.9 | 27.7 | 43.5 |
| 8 | 72.3 | 44.8 | 28.9 | 106.5 | 16.2 | 33.8 | 24.2 | 44.7 |
| 9 | 79.5 | 43.5 | 28.9 | 102.4 | 16.9 | 31.9 | 23.3 | 44.9 |
| 10 | 71.6 | 43.7 | 26.2 | 113.1 | 17.3 | 29 | 22.4 | 44.1 |
| Mean | 74.48 | 42.92 | 28.25 | 109.75 | 16.43 | 30.24 | 24.977 | 45.502 |
| SD | 2.962 | 1.857 | 1.509 | 6.049 | 0.994 | 2.293 | 2.057 | 1.57 |
| CV | 3.98% | 4.33% | 5.34% | 5.51% | 6.05% | 7.58% | 8.24% | 3.45% |
| Standard | 7% | 6% | 12% | 12% | 12% | 12% | 12% | 12% |
| requirement | | | | | | | | |

| Indicator | | | | | ALP | | |
|---|---|---|---|---|---|---|---|
| Nominal | AST (U/L) | | ALT (U/L) | | (U/L) | GGT (U/L) | |
| value | 35 | 147 | 36 | 137 | 114 | 51 | 183 |
| 1 | 34.1 | 156.5 | 32.6 | 133.4 | 109 | 50.5 | 180.9 |
| 2 | 32.4 | 137.8 | 35.1 | 127.5 | 105.8 | 45.2 | 174.5 |
| 3 | 34.5 | 132.7 | 35.2 | 135.5 | 130.3 | 45.4 | 188.7 |
| 4 | 37.1 | 149.3 | 37.4 | 121.1 | 124.6 | 46.9 | 189.3 |
| 5 | 35.7 | 149.5 | 33.6 | 123.1 | 117.5 | 47.9 | 186.6 |
| 6 | 34.9 | 141.1 | 38.3 | 133.2 | 126.9 | 49.6 | 182.8 |
| 7 | 35.8 | 149 | 35.7 | 128.9 | 118.2 | 49.8 | 196 |
| 8 | 34.8 | 143.4 | 32.8 | 126 | 110.1 | 52.5 | 191.7 |
| 9 | 32.1 | 141.1 | 33.2 | 135 | 121.7 | 50.9 | 198.6 |
| 10 | 33.4 | 151.2 | 36.3 | 139 | 118.8 | 44.2 | 189 |
| Mean | 34.48 | 145.16 | 35.02 | 130.27 | 118.29 | 48.29 | 187.81 |
| SD | 1.552 | 7.159 | 1.963 | 5.846 | 8.028 | 2.791 | 7.107 |
| CV | 6.05% | 7.58% | 5.61% | 4.49% | 6.79% | 8.24% | 3.45% |
| Standard | 12% | 12% | 12% | 12% | 12% | 12% | 12% |
| requirement | | | | | | | |

(3) Batch-to-Batch Variation

| Indicator | TP (g/L) | | | ALB (g/L) | | | TB (μmol/L) | | | | | |
|---|---|---|---|---|---|---|---|---|---|---|---|---|
| Nominal value | 72.6 | | | 42.7 | | | 29.1 | | | 99.8 | | |
| Batch No. | 1 | 2 | 3 | 1 | 2 | 3 | 1 | 2 | 3 | 1 | 2 | 3 |
| 1 | 74.9 | 75 | 77.5 | 44.8 | 39.2 | 45.1 | 28.4 | 29.6 | 25.2 | 101.5 | 105.1 | 94.5 |
| 2 | 65.3 | 78.3 | 70.9 | 43.5 | 41 | 46 | 31.8 | 27 | 25 | 112.0 | 107.4 | 101.1 |
| 3 | 72.6 | 68.4 | 76.8 | 43.7 | 45.3 | 43.2 | 27.6 | 26.5 | 29.3 | 106.0 | 111.7 | 92.9 |
| 4 | 68.5 | 72.3 | 72.7 | 46.1 | 41.8 | 43.4 | 30.4 | 27.1 | 27.1 | 99.4 | 107.6 | 101.0 |
| 5 | 70.9 | 71.1 | 76.5 | 40.8 | 45.1 | 45.7 | 28 | 28 | 29.3 | 108.2 | 92.8 | 103.7 |
| 6 | 72.8 | 74.9 | 72 | 43.5 | 43.5 | 48.1 | 32 | 30.6 | 31.7 | 110.0 | 80.9 | 103.3 |
| 7 | 66.1 | 78.1 | 75.1 | 40.9 | 42 | 47.5 | 33.3 | 29.7 | 29.6 | 109.3 | 100.6 | 105.1 |
| 8 | 69.3 | 73.5 | 72.3 | 44.8 | 39.2 | 45.1 | 33.3 | 28.9 | 30.3 | 94.2 | 95.7 | 106.8 |
| 9 | 68.3 | 74.6 | 79.5 | 43.5 | 41 | 46 | 28.7 | 28.9 | 28.9 | 100.7 | 96.7 | 100.0 |
| 10 | 68.2 | 68.2 | 71.6 | 43.7 | 45.3 | 43.2 | 31.1 | 26.2 | 31.7 | 96.7 | 100.6 | 95.2 |
| Mean | 69.69 | 73.43 | 74.48 | 42.92 | 42.146 | 45.123 | 30.46 | 28.25 | 28.81 | 103.8 | 99.9 | 100.4 |
| Overall | 72.534 | | | 43.396 | | | 29.173 | | | 101.4 | | |
| mean | | | | | | | | | | | | |
| Relative | 6.60% | | | 6.86% | | | 7.58 | | | 5.29% | | |
| range | | | | | | | | | | | | |
| Standard | 12% | | | 12% | | | 12% | | | | | |
| requirement | | | | | | | | | | | | |
| Indicator | DB (μmol/L) | | | | | | TBA (μmol/L) | | | | | |
| Nominal value | 16.1 | | | 31.4 | | | 25.1 | | | 45.8 | | |
| Batch No. | 1 | 2 | 3 | 1 | 2 | 3 | 1 | 2 | 3 | 1 | 2 | 3 |
| 1 | 16.1 | 15.4 | 16.1 | 30.5 | 28.4 | 27 | 26.9 | 26.9 | 25.7 | 43.5 | 48.2 | 44.7 |
| 2 | 17.0 | 16.9 | 16.6 | 32.1 | 36.9 | 31.3 | 22.2 | 26.7 | 28.4 | 41.8 | 50.4 | 48.3 |
| 3 | 14.9 | 16.0 | 14.8 | 32.1 | 34.1 | 30.6 | 25.8 | 26.5 | 23.9 | 42.3 | 50.8 | 46.3 |
| 4 | 15.3 | 18.0 | 18.2 | 28.2 | 29.6 | 31.8 | 26 | 26.5 | 28.8 | 43.5 | 48 | 45.3 |
| 5 | 15.3 | 16.7 | 15.7 | 27.5 | 29.1 | 29.8 | 23.9 | 19.7 | 24.2 | 39.2 | 45.2 | 45.2 |
| 6 | 16.9 | 16.4 | 16.1 | 34.5 | 31.3 | 26.3 | 27.3 | 25.8 | 24.9 | 42.9 | 49.6 | 47.9 |
| 7 | 14.5 | 15.5 | 16.2 | 30.1 | 31.1 | 30.9 | 27.7 | 26 | 25.6 | 48.6 | 46.3 | 43.5 |
| 8 | 17.2 | 15.5 | 16.2 | 29.5 | 37.9 | 33.8 | 24.2 | 23.8 | 28.6 | 45.5 | 43 | 44.7 |
| 9 | 15.5 | 16.2 | 15.6 | 27.8 | 32.3 | 31.9 | 23.3 | 31.4 | 22.2 | 44.4 | 47.6 | 44.9 |
| 10 | 17.1 | 16.5 | 16.7 | 27.4 | 37.2 | 29 | 22.4 | 27.6 | 23.3 | 44.2 | 49.7 | 44.1 |
| Mean | 16.0 | 16.3 | 16.2 | 29.97 | 32.79 | 30.24 | 24.977 | 26.08 | 25.557 | 43.585 | 47.882 | 45.502 |
| Overall | 16.2 | | | 31 | | | 25.538 | | | 45.656 | | |
| mean | | | | | | | | | | | | |
| Relative | 3.87% | | | 9.10% | | | 4.32 | | | 9.41 | | |
| range | | | | | | | | | | | | |
| Standard | 12% | | | | | | 12% | | | | | |
| requirement | | | | | | | | | | | | |
| Indicator | AST (U/L) | | | | | | ALT (U/L) | | | | | |
| Nominal value | 35 | | | 36 | | | 137 | | | 45.8 | | |
| Batch No. | 1 | 2 | 3 | 1 | 2 | 3 | 1 | 2 | 3 | 1 | 2 | 3 |
| 1 | 36.1 | 34.6 | 34.1 | 123.6 | 150.7 | 156.5 | 37.5 | 34.9 | 32.6 | 133.4 | 147.4 | 132.4 |
| 2 | 36.7 | 33.7 | 32.4 | 144.7 | 139.6 | 137.8 | 32.9 | 38.3 | 35.1 | 127.5 | 155 | 131.2 |
| 3 | 34.7 | 30.1 | 34.5 | 154.5 | 162.1 | 132.7 | 37 | 37.8 | 35.2 | 135.5 | 122.7 | 136 |
| 4 | 35.6 | 36.9 | 37.1 | 136.8 | 149.4 | 149.3 | 39.5 | 38.2 | 37.4 | 121.1 | 132.2 | 135.4 |
| 5 | 29.8 | 33.4 | 35.7 | 142.2 | 162.6 | 149.5 | 36 | 34.8 | 33.6 | 123.1 | 149.1 | 135.3 |
| 6 | 35.1 | 33.1 | 34.9 | 133.6 | 146.9 | 141.1 | 33.5 | 40.2 | 38.3 | 133.2 | 136 | 138.4 |
| 7 | 31.2 | 31.6 | 35.8 | 147.4 | 145.9 | 149 | 37.8 | 40.8 | 35.7 | 128.9 | 140.9 | 135.5 |
| 8 | 29.1 | 38 | 34.8 | 123.5 | 166.2 | 143.4 | 38.6 | 39 | 32.8 | 126 | 157.9 | 133.6 |
| 9 | 28.8 | 37.1 | 32.1 | 152.4 | 152.2 | 141.1 | 35.1 | 41.1 | 33.2 | 135 | 158.6 | 122.8 |
| 10 | 35.6 | 36.2 | 33.4 | 156.5 | 148.1 | 151.2 | 35.4 | 38.4 | 36.3 | 139 | 139.4 | 117.9 |
| Mean | 33.27 | 34.47 | 34.48 | 141.52 | 152.37 | 145.16 | 36.33 | 38.35 | 35.02 | 130.27 | 143.92 | 131.85 |
| Overall | 34.07% | | | 146.35% | | | 36.567 | | | 135.347 | | |
| mean | | | | | | | | | | | | |
| Relative | 3.55% | | | 7.41% | | | 9.11% | | | 9.41% | | |
| range | | | | | | | | | | | | |
| Standard | 12% | | | | | | 12% | | | | | |
| requirement | | | | | | | | | | | | |

| Indicator | ALP (U/L) | GGT (U/L) | |
|---|---|---|---|
| Nominal value | 114 | 51 | 183 |

| Batch No. | 1 | 2 | 3 | 1 | 2 | 3 | 1 | 2 | 3 |
|---|---|---|---|---|---|---|---|---|---|
| 1 | 98.5 | 117.8 | 109 | 50.5 | 53.5 | 49.6 | 175.8 | 176.3 | 180.9 |
| 2 | 101.3 | 94.7 | 105.8 | 45.2 | 46.9 | 53.8 | 167.8 | 189.9 | 174.5 |
| 3 | 98 | 110.8 | 130.3 | 45.4 | 52.7 | 51.3 | 176.5 | 177 | 188.7 |
| 4 | 117.7 | 109.8 | 124.6 | 46.9 | 52.1 | 53 | 185 | 177.2 | 189.3 |
| 5 | 124.5 | 106.1 | 117.5 | 47.9 | 52.2 | 51.1 | 170.9 | 170.5 | 186.6 |
| 6 | 113 | 115.1 | 126.9 | 49.6 | 48 | 53.2 | 193.3 | 197.2 | 182.8 |
| 7 | 114.2 | 107.9 | 118.2 | 49.8 | 58.7 | 56.4 | 184.8 | 195.5 | 196 |
| 8 | 112.7 | 105 | 110.1 | 52.5 | 54.8 | 52.6 | 178.7 | 212.1 | 191.7 |
| 9 | 97.6 | 123.4 | 121.7 | 50.9 | 54.8 | 55.6 | 180.4 | 182.9 | 198.6 |
| 10 | 100.4 | 122.8 | 118.8 | 44.2 | 57.4 | 49.3 | 159 | 188 | 189 |
| Mean | 107.79 | 111.34 | 118.29 | 48.29 | 53.11 | 52.59 | 177.22 | 186.66 | 187.81 |
| Overall | 112.473 | | | 25.538 | | | 45.656 | | |
| mean | | | | | | | | | |
| Relative | 9.34 | | | 4.32 | | | 9.41 | | |
| range | | | | | | | | | |
| Standard | 12% | | | 12% | | | | | |
| requirement | | | | | | | | | |

It can be seen from the above that the product of the present invention can achieve better performance, and the product detection results are accurate and stable.

The above descriptions are only preferred embodiments of the present invention, and are not intended to limit the present invention. Those skilled in the art can make various changes, modifications, substitutions and alterations to these embodiments without departing from the principles and spirit of the present invention. The scope of the invention is defined by the claims and their equivalents.

What is claimed is:

1. A multifunctional microfluidic detection chip, wherein the chip comprises a chip body, on which a sample injection chamber, a sample quantitative chamber, a sample overflow chamber, a diluent storage chamber, a diluent quantitative chamber, a diluent overflow chamber, a quantitative mixing chamber, a reaction chamber and vent holes are disposed;
the sample injection chamber is used for injecting a reaction sample to be detected, and is connected to the sample quantitative chamber through a microfluidic channel, the reaction sample enters the sample quantitative chamber from the sample injection chamber, and the excess reaction sample enters the sample overflow chamber;
the diluent storage chamber is connected to the diluent quantitative chamber through a microfluidic channel, a diluent enters the diluent quantitative chamber from the diluent storage chamber, and the excess diluent enters the diluent overflow chamber;
the reaction chamber includes one or more reaction cavities and a sample blank cavity;
after the reaction sample in the sample quantitative chamber is mixed with the diluent in the diluent quantitative chamber uniformly in the quantitative mixing chamber, mixed liquid enters the reaction cavities through microfluidic channels and reacts with a reaction reagent therein for detection, and the mixed liquid enters the sample blank cavity at the same time as a sample blank for detection;
the three-dimensional size of the reaction cavities is the same as that of the sample blank cavity;
channel of the sample blank cavity is wider than those of the reaction cavities;
the quantitative ratio of the reaction sample to the diluent in the quantitative mixing chamber is less than 1:30.

2. The multifunctional microfluidic detection chip of claim 1, wherein the sample quantitative chamber includes a first sample quantitative cavity and a second sample quantitative cavity.

3. The multifunctional microfluidic detection chip of claim 1, wherein the reaction chamber includes a plurality of equidistantly distributed reaction cavities.

4. The multifunctional microfluidic detection chip of claim 1, wherein after the reaction sample in the sample quantitative chamber and the diluent in the diluent quantitative chamber enter the quantitative mixing chamber through microfluidic channel I and microfluidic channel II respectively and are mixed uniformly, the mixed liquid enters the reaction cavities and the sample blank cavity through microfluidic channel III and microfluidic channel IV successively, the microfluidic channel I, the microfluidic channel II and the microfluidic channel III respectively include an inflection point which is close to the center of the chip body relative to the corresponding liquid outflow chamber.

5. The multifunctional microfluidic detection chip of claim 1, wherein the quantitative mixing chamber and the reaction chamber are respectively communicated with the vent holes.

6. The multifunctional microfluidic detection chip of claim 1, wherein the quantitative ratio of the reaction sample to the diluent in the quantitative mixing chamber is 1:50.

7. The multifunctional microfluidic detection chip of claim 1, wherein the reaction reagent is lyophilized beads prepared by lyophilization.

8. The multifunctional microfluidic detection chip of claim 7, wherein the lyophilized beads have a radius ranging from 0.5 mm to 1 mm.

9. The multifunctional microfluidic detection chip of claim 1, wherein the microfluidic channel between the sample quantitative chamber and the sample overflow chamber is provided with a sample vent channel connected to the outside of the chip, and the microfluidic channel between the diluent quantitative chamber and the diluent overflow chamber is provided with a diluent vent channel connected to the outside of the chip.

10. The multifunctional microfluidic detection chip of claim 1, wherein the chip has a fan-shaped structure.

11. The multifunctional microfluidic detection chip of claim 1, wherein the chip further includes a chip upper layer and a chip middle layer, and the chip body is located at lower layer.

12. The multifunctional microfluidic detection chip of claim 1, wherein two sides of the chip body are respectively provided with a splicing slot.

13. The multifunctional microfluidic detection chip of claim 1, wherein the chip body is used for detection in biochemical items, immune items, nucleic acid molecule items, and blood coagulation items.
